(19) United States
(12) Patent Application Publication
(10) Pub. No.: US 2017/0303525 A1
(43) Pub. Date: Oct. 26, 2017

(54) PEST SWATTER

(71) Applicants: Eddie Chatman, Macomb, MI (US); Sandra Chatman, Macomb, MI (US)

(72) Inventors: Eddie Chatman, Macomb, MI (US); Sandra Chatman, Macomb, MI (US)

(21) Appl. No.: 15/371,354

(22) Filed: Dec. 7, 2016

Related U.S. Application Data
(60) Provisional application No. 62/327,551, filed on Apr. 26, 2016.

(51) Int. Cl. A01M 3/02

(52) U.S. Cl. CPC A01M 3/022

(57) ABSTRACT

A pest swatting device that includes: a top sticky surface; a pad tablet of sticky surfaces, where the pad tablet of sticky surfaces includes a plurality of sticky surfaces; and a handle, where the handle extends from the swatting surface. The pest swatting device preferably includes a plurality of holes through the top sticky surface and the plurality of sticky surfaces. Each of the plurality of sticky surfaces are individually adapted for removal after use and the pad tablet of sticky surfaces is adapted for replacement after each sticky surface has been removed.

### BACKGROUND OF THE INVENTION

### Field of Invention

The present invention relates to a pest swatter that functions as a means to control flying insects and other bugs.

### Description of Related Art

Various products are available to control bugs, flies, gnats and other insects. These products range from mechanical devices such as the traditional fly swatter in addition to sprays, traps and other products. One drawback to the use of bug and pest sprays is the toxic materials that are used in the chemical composition related to the spray. The traditional flyswatter, although effective, has a drawback of leaving the residue of the smashed bug or fly on the contact surface. The swatter is however a quite effective device and further is not an environmental hazard such as bug spray.

### SUMMARY OF THE INVENTION

The present invention relates to a pest swatting device that includes: a top sticky surface; a pad tablet of sticky surfaces, where the pad tablet of sticky surfaces includes a plurality of sticky surfaces; and a handle, where the handle extends from the swatting surface. The pest swatting device preferably includes a plurality of holes through the top sticky surface and the plurality of sticky surfaces. Each of the plurality of sticky surfaces are individually adapted for removal after use and the pad tablet of sticky surfaces is adapted for replacement after each sticky surface has been removed.

### BRIEF DESCRIPTION OF DRAWINGS

FIG. 1 depicts a pest swatter in accordance with the present invention.

### DETAILED DESCRIPTION

The present invention relates to a pest swatter that provides a convenient and effective means to kill and dispose of flying insects or bugs. The present invention includes a handle and a swatting surface similar to a conventional flyswatter. However the swatting surface includes a sticky pad with a series of holes through the pad that allow for swift movement of the swatter. In contrast to the traditional swatter, a sticky surface provided over the swatting surface. The sticky surface allows for the attachment of the insect or bug onto the surface of the swatter and then is easily removed from the surface of the swatter for disposal. This sticky pad may include a series of individual sticky surfaces stacked on top of each other. The sticky surface functions similar to tape, so it is easily removed and torn to expose a new usable swatting surface for the user. The swatting surface is therefore easily replaceable with a new pad of sticky swatting surfaces.

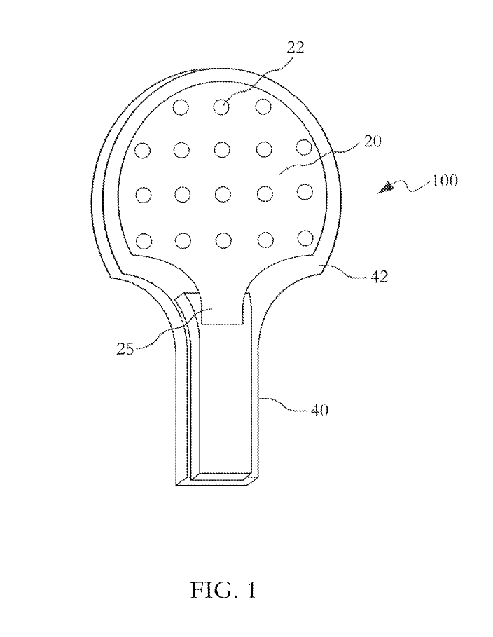

In reference to FIG. 1, a pest swatter 100 in accordance with the present invention is depicted. The pest swatter 100 includes a sticky pad 20 with a plurality of holes 20 over the surface of the sticky pad 20. The sticky pad 20 may include a series of sticky-type material that is removed after use thereof. As a result, a user may remove this initial surface and replace it with an underlying surface on Pad tablet 25 that is provided. The Pad tablet 25 attaches to the top end of the end of a handle 40 of the Pest Swatter 100. Once the pad tablet 25 is extinguished or completed a new pad tablet of sticky surfaces may be inserted onto the swatting surface of the Pest Swatter 100. The pad tablet 25 extends over a base 42. The base 42 attaches to the handle 40 and provides a firm support for the pad tablet 25. The Pest Swatter 100 therefore provides an interchangeable surface with a sticky substance that essentially enables insect or bug residue to be trapped on the sticky surface and removed after use. A new surface is provided on the underlying pad, which is replaceable on the overall swatting surface of the Pest Swatter 100. The instant invention has been shown and described in what it considers to be the most practical and preferred embodiments. It is recognized, however, that departures may be made there from within the scope of the invention and that obvious modifications will occur to a person skilled in the art.

What is claimed is:

1. A pest swatting device comprising:
a. a top sticky surface;
b. a pad tablet of sticky surfaces, where the pad tablet of sticky surfaces includes a plurality of sticky surfaces; and
c. a handle, where the handle extends from the swatting surface.

2. The pest swatting device according to claim 1, where further including a plurality of holes through the top sticky surface and the plurality of sticky surfaces.

3. The pest swatting device according to claim 2, where each of the plurality of sticky surfaces are individually adapted for removal after use.

4. The pest swatting device according to claim 1, wherein the pad tablet of sticky surfaces is adapted for replacement after each sticky surface has been removed.
